(19) United States
(12) Patent Application Publication
(10) Pub. No.: US 2006/0045681 A1
(43) Pub. Date: Mar. 2, 2006

(54) Refuse cart lifter with an improved range of rotation

(76) Inventors: Billy K. Bayne, Simpsonville, SC (US); Jimmy M. Biggerstaff, Pauline, SC (US)

Correspondence Address: MCANDREWS HELD & MALLOY, LTD, 500 WEST MADISON STREET, SUITE 3400, CHICAGO, IL, 60661, US

(21) Appl. No.: 11/117,220

(22) Filed: Apr. 28, 2005

Related U.S. Application Data
(63) Continuation-in-part of application No. 10/803,281, filed on Mar. 18, 2004.
(60) Provisional application No. 60/455,546, filed on Mar. 18, 2003.

(51) Int. Cl. B65F 3/02

(52) U.S. Cl. 414/408

(57) ABSTRACT

A lifter is disclosed which allows for an improved operating envelope of the faceplate. The lifter utilizes a motor having 210 degrees of rotation and lifting arms of a unique geometry to rotate a faceplate from a retracted position below and substantially behind the lifter baseplate to a dumping position above and substantially behind a lower hopper edge for the purpose of dumping refuse carts into a refuse collection vehicle. This dumps refuse further into the vehicle hopper, which minimizes the number of packing cycles required on a collection route. A faceplate is attached to the motor using two lifting arms. The faceplate has a fixed upper hook and may be configured with a sliding, retractable lower hooking mechanism or a spring loaded, cam actuated rotating hook mechanism. The faceplate may include multiple sets of attachment points for attaching the lifting arms to facilitate the mounting of the lifter on a refuse collection vehicle over a range of heights without necessitating replacement of the lifting arms.

### RELATED APPLICATIONS

This application is a continuation-in-part of U.S. patent application Ser. No. 10/803,281, entitled “Refuse Cart Lifter With An Improved Range Of Rotation” (Attorney Docket 14893US02), filed Mar. 18, 2004, which makes reference to, claims priority to, and claims the benefit of U.S. Provisional Patent Application Ser. No. 60/455,546, entitled “Refuse Collection Cart Lifter With An Improved Range Of Rotation” (Attorney Docket 14893US01), filed Mar. 18, 2003, the complete subject matter of which is hereby incorporated herein by reference in its entirety.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

The present invention relates to refuse container lifting devices, and in particular to refuse cart lifting devices. Refuse containers are often quite heavy, and therefore refuse collection vehicles are generally equipped with refuse container lifting devices to assist the vehicle operator when emptying the refuse containers. However, a refuse collection vehicle may encounter several different types of refuse containers on a given collection route, and the differences in these refuse containers often require the use of separate lifting devices. For example, large commercial refuse containers, or dumpsters, are typically emptied by tipping the container over the edge of the vehicle hopper using a variety of lifting devices, including tipper bars and cable and winch arrangements.

Refuse carts are relatively light refuse receptacles constructed from various plastics and other synthetic materials. Features of refuse carts may include for example hinged covers, locking covers, wheels, and handles in various locations and configurations. Capacities generally range for example from 30 gallons to 95 gallons. Refuse carts typically encountered in residential areas are emptied using a refuse cart lifter capable of engaging the refuse cart, lifting it, and inverting the refuse cart to empty refuse into the vehicle hopper.

Many prior refuse cart lifters present a wide profile and thus protrude from the refuse collection vehicle so as to interfere with the emptying of commercial dumpsters when they are tipped over the edge of the vehicle hopper. Protruding cart lifters also created a hazard for the rear-loading refuse collection vehicle driver when backing up, and the side-loading refuse collection driver when navigating narrow roadways, such as alleys. Some lifter designs have addressed this problem by locating the lifter off to the side of or even completely beneath the refuse collection vehicle hopper. Others attempted to reduce the profile of the refuse cart lifter to address the lifter protrusion issue.

Another problem in the refuse cart lifter industry is that cart lifters typically hang down from the refuse collection vehicle, and therefore reduce the vehicle's ground clearance, particularly on uneven ground. Thus, some lifter designs include a retracted position where the lifter faceplate is angled underneath the refuse collection vehicle hopper, rather than hanging straight down.

Yet another issue involves refuse compaction cycles. Prior cart lifters continuously dump refuse into the portion of the vehicle hopper closest to the refuse cart lifter because these lifters cannot empty the refuse cart a substantial distance into the hopper when dumping. The refuse therefore quickly accumulates near the refuse cart lifter, which requires the vehicle operator to stop collecting carts and compact the refuse to prevent interference with the next lifter dumping cycle. Thus, a lifter that empties refuse carts further into the refuse collection vehicle hopper would decrease the amount of time and energy spent compacting refuse between refuse cart dumping.

A further issue involves maintenance of the lifter. Elevated hydraulic loads associated with some lifters correspond to increased wear and strain on cart lifter systems. Also, some lifter motor designs are readily susceptible to damage from contaminants present in the hydraulic system and eventually require complex repairs or rebuilding that can typically only be performed at the manufacturer's facility. Many lifters also use bearings that require regular greasing.

A separate issue involves the effect of varying dimensions associated with lifting points on the refuse carts with respect to lifter engagement. For example, the distance between lifting points on refuse carts is set to industry standards. In practice, however, the distance between lifting points can vary appreciably. If the distance is significantly less than the industry standard, substantial force may be applied to the lifting points by the lifter's engagement mechanism. Such force can damage the refuse cart lifting points and reduce the effective life of the lifter. On the other hand, if the distance is significantly greater than the industry standard, the lifter's engagement mechanism may fail to engage the refuse cart during dumping, resulting in dropped and damaged refuse carts. Thus, a lifter engagement mechanism that can adjust to the varying dimensions between refuse container lifting points would contribute to longer refuse cart and lifter life, while improving the lifter's refuse cart engagement while dumping refuse carts.

Yet another problem with existing lifters is their limited ability to control the timing of the latch mechanism that engages the refuse container lifting points during dumping. For example, the timing of the operation of a typical sliding latch is dependent on the length of an actuating arm or member. Since the actuating arm or member is rigid and secured to fixed locations on the lifter, significant modifications must be made to the actuating arm or member attachment points if a longer actuating arm or member is used. Therefore, it would be advantageous to provide a means of controlling the timing of the actuation of the latch mechanism that is not dependent on the length of the actuating arm or member.

A further related problem with many existing lifters is associated with the range of ground to sill height and tailgate angle conditions encountered by refuse collection vehicles on a routine basis. For instance, the phenomenon known as “suck back” refers to the situation where a lifter's latch system engages early in the upward dumping rotation of the lifter and therefore becomes fully extended before the end of a dumping cycle, which causes the latch to retract slightly during the last few degrees of upward dumping rotation. This situation can lead to dropping of the refuse containers into the hopper near the end of the dumping cycle. Conversely, the container may be located such that the lifter's latch system engages late in the upward dumping rotation of the lifter, which can cause difficulty in engaging the refuse container, or damage to the container when the lifter's latch system releases the container before the container reaches the ground. Thus, it would be advantageous to provide a means of controlling the timing of the actuation of the latch mechanism to compensate for varying pick up conditions.

Another problem involves the mounting height of the lifter. Due to the standard height of the lifting points on refuse containers, the target height for the upper engagement member of a lifter during initial engagement of the refuse cart is approximately 34 inches. However, the angle of the faceplate relative to the refuse cart must also be considered. If the lifter faceplate is at an angle to the refuse cart of approximately eleven degrees or more when the lifter's upper engagement member reaches a height of approximately 34 inches during lifter operation, the lifter faceplate may cause the refuse cart to kick away from the lifter before the lower engagement member engages with the lower lifting point of the refuse cart. Given a fixed lifter arm length, the angle of the faceplate to the refuse cart during initial refuse cart engagement is dependent upon the height at which the lifter is mounted on the refuse collection vehicle. Hence, numerous lifter arm lengths are required to accommodate a range of lifter mounting heights while maintaining the required initial engagement faceplate angle. Providing numerous lifter arm lengths requires additional expense, time and effort to change out. A lifter capable of maintaining the required initial engagement faceplate angle over a range of mounting heights while requiring a minimum of lifter arm length changes is therefore desirable.

Thus, a need exists in the refuse collection industry for a residential refuse cart lifter that: possesses a slim profile; provides improved ground clearance; decreases the amount of time and energy spent compacting refuse between the emptying of successive refuse carts; provides needed lifting capacity at lower hydraulic pressures; requires little maintenance; is easy to repair or rebuild at the end user's facility; provides a lifter engagement mechanism that can adjust to the varying dimensions between refuse container lifting points; provides a means of controlling the timing of the actuation of the latch mechanism; and is capable of maintaining an acceptable initial engagement faceplate angle over a range of mounting heights while requiring a minimum of lifter arm length changes to do so.

### SUMMARY OF THE INVENTION

The present refuse cart lifter has an improved operating envelope resulting from a wide range of rotation of the lifter faceplate in combination with a unique lifter arm design. This yields a refuse cart lifter that may be capable of being retracted when not in use for increased ground clearance, while also capable of dumping refuse further into the refuse collection vehicle hopper than prior lifters. This added dumping range increases the efficiency of refuse collection because a vehicle operator does not have to operate the vehicle's packing blade as frequently, resulting in savings in time and energy.

The presently preferred version of the refuse cart lifter utilizes a slim profile motor to rotate a lifting arm and faceplate 210 degrees for the purpose of dumping refuse containers into a receptacle. It is preferable to use a dual rack and single pinion hydraulically actuated unit as the motor due to its thin profile and superior lifting capacity at lower hydraulic pressures. This motor design also is preferable due to its open gear design, which makes it less susceptible to damage from contaminants in the hydraulic fluid system, and for the ease with which the lifter can be repaired or rebuilt at the end users facility. This actuator may based on the design disclosed in U.S. Pat. No. 4,773,812, which is hereby incorporated by reference.

The present refuse cart lifter may include a faceplate having multiple sets of lifting arm attachment points that allow the faceplate angle relative to the lifting arms to be changed without negatively affecting the operation of the lifter's latch mechanism. The use of alternate lifting arm attachment points reduces the number of lifting arm lengths required to maintain an acceptable initial engagement faceplate angle over a range of mounting heights.

The faceplate is preferably attached to the motor using two lifting arms having a unique design that is capable of directing the faceplate substantially into the vehicle hopper when used with a motor having a wide range of rotation. This allows the lifter to be more compact in its home (retracted) position and improves ground clearance when mounted on the rear of a rear loading refuse collection vehicle. The faceplate may have one fixed saddle and one moveable latch mechanism. The latch mechanism may be based on the sliding latch design that is disclosed in U.S. Pat. No. 5,308,211 and related patents, which are hereby incorporated by reference, or a cam-driven, spring loaded latch as discussed below. The latter mechanism may accommodate varying dimensions between refuse container lifting points, and provides a means of controlling the timing of the actuation of the latch mechanism.

The present lifter may also incorporate an adjustable faceplate having multiple sets of attachment points for the lifting arms. This feature may advantageously enable the lifter to be mounted to a refuse collection vehicle over a range of mounting heights while maintaining an operable saddle height and faceplate angle relative to the refuse cart without changing the length of the lifting arms by simply attaching the lifting arms to the faceplate at different sets of attachment points. This feature therefore may save time and money when mounting the same lifter on different vehicles with varying mounting heights.

Other design features may include the use of composite bearing materials in exposed bearing areas, such as the bearings that form a part of the sliding latch guide, to make the unit more maintenance free by eliminating the need for regular greasing. Also, longer lifting and latch arms may be utilized to allow for mounting the lifter on the side of a side-loading refuse collection vehicle.

The present lifter faceplate may extend partially underneath the refuse collection vehicle in the retracted position, and therefore may not protrude significantly outward of the refuse cart lifter motor. The slim profile of the lifter motor and the retracted position of the faceplate may function to preclude interference with the dumping of large commercial containers over the lifter. Thin bumpers may also be mounted to the vehicle to protect the lifter as large commercial containers are dumped into the hopper.

To empty a residential refuse cart into the hopper of the refuse collection vehicle, the lifter commences an emptying cycle. During the emptying cycle, the lifter motor rotates the lifter faceplate from a retracted position partially beneath the vehicle such that a fixed saddle engages the refuse cart. As the lifter continues to rotate, the cart is lifted in a sweeping arc motion towards the hopper. Meanwhile, the latch mechanism engages a lower lifting point on the refuse cart to prevent the loss of the cart into the hopper as the cart is emptied. If using a sliding latch, a sliding latch guide can be incorporated to prevent unwanted movements of the sliding latch during operation, which includes bearings to reduce friction while sliding. At the end of the emptying cycle, the cart is positioned significantly inward of the outer hopper edge.

An unloading cycle reverses the emptying cycle and the cart is brought back down to street level in a sweeping arc motion. As the cart descends, the sliding latch disengages the lower lifting point on the refuse cart, followed by the disengagement of the upper saddle and upper lifting point on the refuse cart after the cart reaches the ground. The lifter can then be rotated further until the faceplate returns to the retracted position, substantially under the refuse collection vehicle.

### BRIEF DESCRIPTION OF SEVERAL VIEWS OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an exemplary refuse cart lifter in accordance with the present invention incorporating a sliding latch mechanism shown in a retracted position;

FIG. 2 is a perspective view of an exemplary refuse cart lifter in accordance with the present invention incorporating a sliding latch mechanism shown in an intermediate position;

FIG. 3 is a perspective view of an exemplary refuse cart lifter in accordance with the present invention incorporating a sliding latch mechanism shown in a dumping position;

FIG. 4 is a side view of an exemplary refuse cart lifter in accordance with the present invention incorporating a sliding latch mechanism shown in a retracted position;

FIG. 5 is a side view of an exemplary refuse cart lifter in accordance with the present invention incorporating a sliding latch mechanism shown in an intermediate position;

FIG. 6 is a side view of an exemplary refuse cart lifter in accordance with the present invention incorporating a sliding latch mechanism shown in a dumping position;

FIG. 7 is a front view of an exemplary refuse cart lifter in accordance with the present invention incorporating a sliding latch mechanism shown in a retracted position;

FIG. 8 is a front view of an exemplary refuse cart lifter in accordance with the present invention incorporating a sliding latch mechanism shown in a dumping position;

FIG. 9 is a side view of an exemplary refuse cart adjacent to a refuse cart lifter in accordance with the present invention incorporating a sliding latch mechanism shown in a retracted position;

FIG. 10 is a side view of an exemplary refuse cart lifter in accordance with the present invention incorporating a sliding latch mechanism shown engaging the upper lifting point of an adjacent refuse cart;

FIG. 11 is a side view of an exemplary refuse cart lifter in accordance with the present invention incorporating a sliding latch mechanism shown in a dumping position engaging the upper and lower lifting points of a refuse cart;

FIG. 12 is a perspective view of an exemplary refuse cart adjacent to a refuse cart lifter in accordance with the present invention incorporating a sliding latch mechanism shown in a retracted position;

FIG. 13 is a perspective view of an exemplary refuse cart lifter in accordance with the present invention incorporating a sliding latch mechanism shown engaging the upper lifting point of an adjacent refuse cart;

FIG. 14 is a perspective view of an exemplary refuse cart lifter in accordance with the present invention incorporating a sliding latch mechanism shown in a dumping position engaging the upper and lower lifting points of a refuse cart;

FIG. 15 depicts the rear of a rear-loading refuse collection vehicle showing two lifters in accordance with the present invention incorporating a sliding latch mechanism mounted to the rear of the refuse collection vehicle;

FIG. 16 is a side view of an exemplary refuse cart lifter in accordance with the present invention incorporating a sliding latch mechanism shown in a retracted position and mounted on a rear-loading refuse collection vehicle;

FIG. 17 is a partially cut away side view of an exemplary refuse cart lifter in accordance with the present invention incorporating a sliding latch mechanism shown in a dumping position and mounted on a rear-loading refuse collection vehicle;

FIG. 18 is a perspective view of an exemplary refuse cart lifter in accordance with the present invention incorporating a spring loaded, cam actuated latch mechanism shown in a retracted position;

FIG. 19 is a perspective view of an exemplary refuse cart lifter in accordance with the present invention incorporating a spring loaded, cam actuated latch mechanism shown in an intermediate position;

FIG. 20 is a perspective view of an exemplary refuse cart lifter in accordance with the present invention incorporating a spring loaded, cam actuated latch mechanism shown in a dumping position;

FIG. 21 is a side view of an exemplary refuse cart lifter in accordance with the present invention incorporating a spring loaded, cam actuated latch mechanism shown in a retracted position;

FIG. 22 is a front view of an exemplary refuse cart lifter in accordance with the present invention incorporating a spring loaded, cam actuated latch mechanism shown in a retracted position;

FIG. 23 is a top view of an exemplary refuse cart lifter in accordance with the present invention incorporating a spring loaded, cam actuated latch mechanism shown in a retracted position;

FIG. 24 is a perspective view of an exemplary refuse cart lifter in accordance with the present invention incorporating a spring loaded, cam actuated latch mechanism and multiple sets of faceplate mounting holes, the lifter shown in a retracted position;

FIG. 25a is a side view of an exemplary refuse cart lifter utilizing the outer set of faceplate mounting holes shown in a retracted position;

FIG. 25b is a side view of an exemplary refuse cart lifter utilizing the outer set of faceplate mounting holes shown in an intermediate position;

FIG. 25c is a side view of an exemplary refuse cart lifter utilizing the outer set of faceplate mounting holes shown in a dumping position;

FIG. 26a is a side view of an exemplary refuse cart lifter utilizing the inner set of faceplate mounting holes shown in a retracted position;

FIG. 26b is a side view of an exemplary refuse cart lifter utilizing the inner set of faceplate mounting holes shown in an intermediate position; and

FIG. 26c is a side view of an exemplary refuse cart lifter utilizing the inner set of faceplate mounting holes shown in a dumping position.

### DETAILED DESCRIPTION OF THE INVENTION

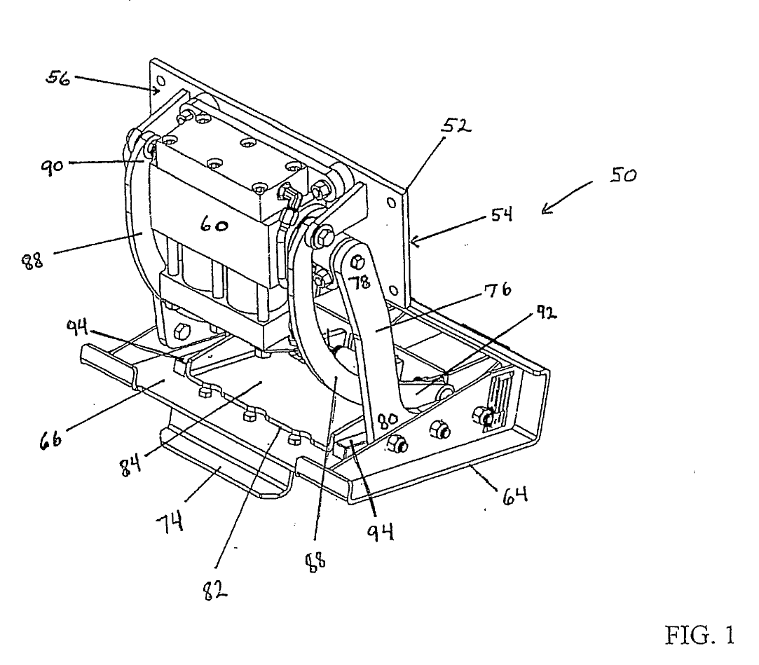

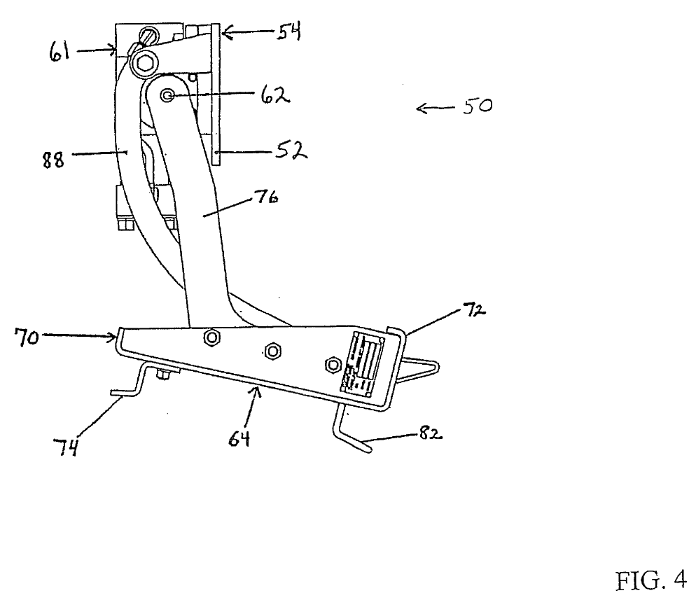

FIG. 1 depicts a first preferred embodiment of the present refuse cart lifter 50 shown in a retracted position. The motor 60 is affixed to the front side 56 of the baseplate 52. The motor 60 depicted is a dual rack, single pinion hydraulic actuator capable of 210 degrees of rotation. Those skilled in the art, however, will appreciate that other motors may be adopted for use with the present invention. The rear side 54 of baseplate 52 can be attached to a refuse collection vehicle or a large refuse collection container. Dual lifting arms 76 are attached at a first end 78 of the lifting arms 76 to the rotatable shaft 62 (see FIG. 4) of motor 60. The second end 80 of the lifting arms 76 are attached to the faceplate 64. In this view, the inner surface 66 of faceplate 64 is clearly visible, as is the saddle 74.

The inner surface 84 of a portion of the sliding latch 82 is also seen. The sliding latch 82 is connected to the baseplate 52 with dual latch arms 88. A first end 90 of the latch arms 88 is pivotally connected to the front side 56 of baseplate 52. A second end 92 of the latch arms 88 is rigidly connected to the sliding latch 82. A pair of sliding latch guides 94 which limit undesirable sliding latch 82 movement in relation to faceplate 64 is also depicted.

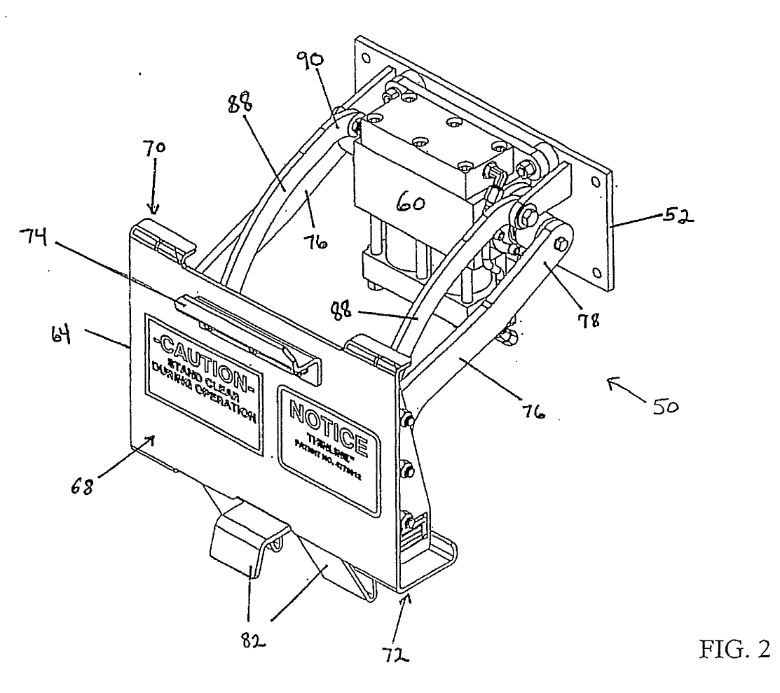

FIG. 2 depicts the first preferred embodiment of present refuse cart 50 lifter shown in an intermediate position. In this figure, the motor 60 has rotated the lifting arms 76 and swung faceplate 64 to a position essentially parallel to baseplate 52. Note that latch arms 88 have also swung upwards with the sliding latch 82, which has yet to slide in relation to faceplate 64 due to the geometry of the lifting arms 76 in relation to the latch arms 88. Also shown in this figure is the location of the upper end 70 and the lower end 72 of faceplate 64.

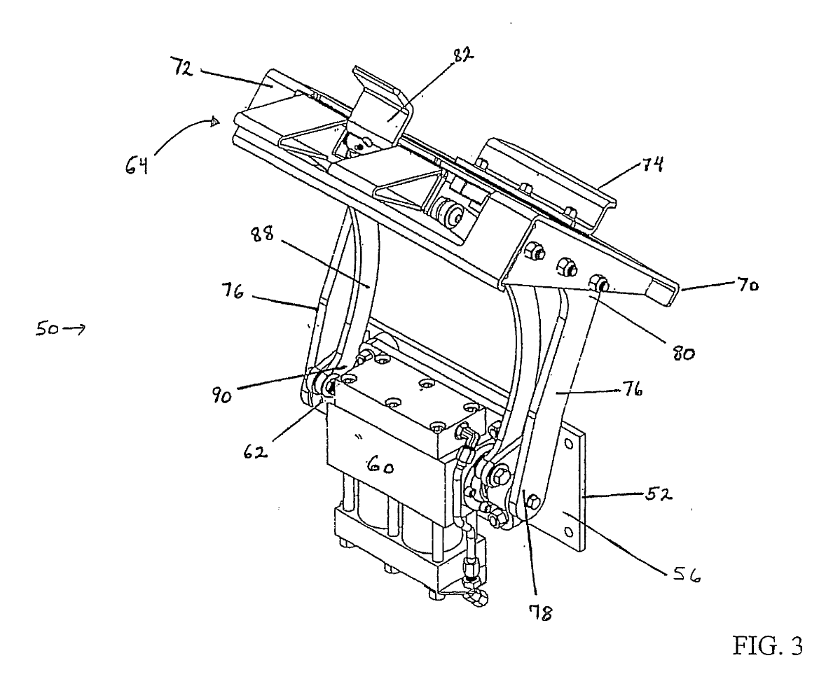

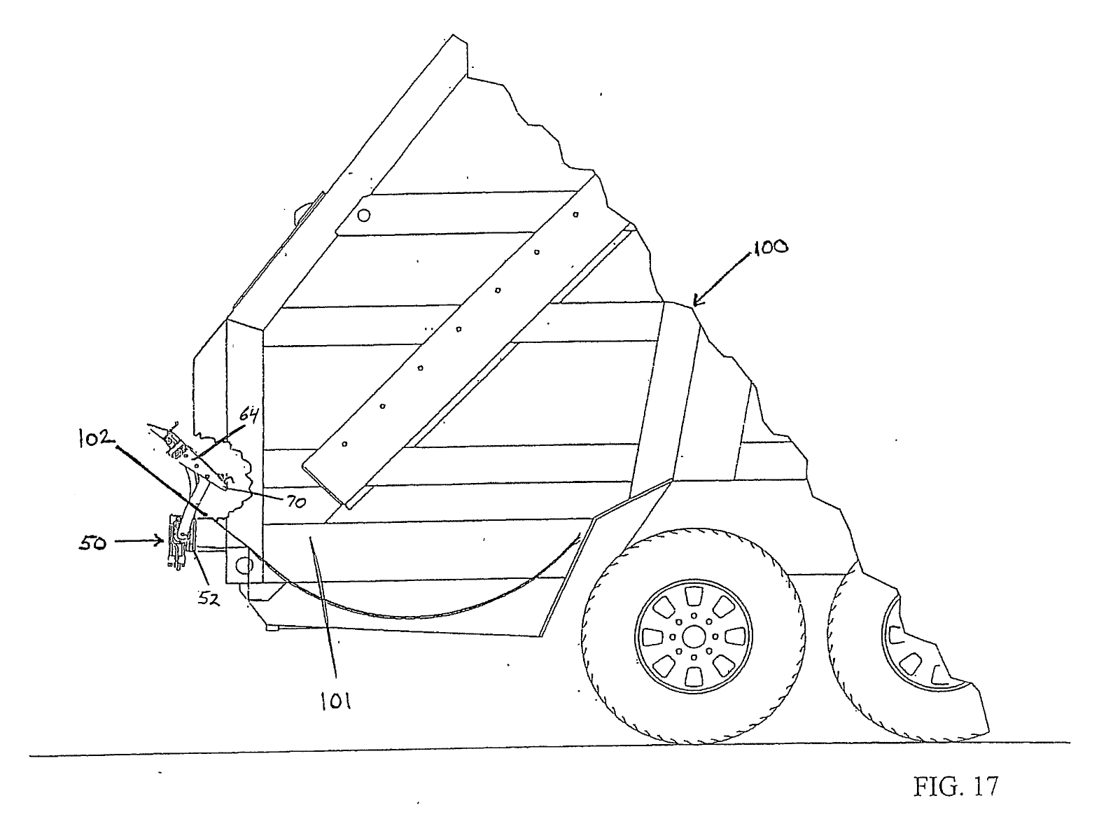

FIG. 3 depicts the first embodiment of the present refuse cart 50 lifter shown in a dumping position, which is the extreme opposite of the retracted position depicted in FIG. 1. In FIG. 3, the motor 60 has further rotated rotatable shaft 62 and attached lifting arms 76 preferably past a vertical position. The resulting angle of the first end 78 of lifting arms 76 away from the back side 54 of the baseplate 52 (see FIG. 4) or towards the hopper if the present refuse cart lifter 50 is mounted on a refuse collection vehicle (see FIG. 17), combined with the design of the lifting arms 76 that directs the second end 80 of lifting arms 76 even further away from the back side 54 of the baseplate 52 serves to swing faceplate 64 to a position above and substantially behind baseplate 52. Lifting arm 76 design directs the second end 80 of lifting arms 76 away from the back side 54 of the baseplate 52 (see FIG. 1) by offsetting the second end 80 of lifting arm 76 from lifting arm 76 using, for example, a curve or an angle in lifting arm 76. This wide range of rotation of motor 60 and unique geometry of lifting arms 76 facilitates the dumping of refuse further into the refuse receptacle or refuse collection vehicle hopper than otherwise possible using existing lifters.

Latch arms 88 have also swung upwards with the sliding latch 82. The first ends 90 of latch arms 88 are pivotally attached to the front side 56 of baseplate 52, while the second ends 92 of latch arms 88 (seen better in FIG. 1) are fixedly attached to sliding latch 82. Latch arms 88 are of a length and geometry calculated to cause the sliding latch 82 to slide away from saddle 74 of faceplate 64 and engage the refuse cart at some point after faceplate 64 moves from the intermediate position depicted in FIG. 2 to the dumping position in FIG. 3. A sliding latch guide 94 (see FIG. 1) prevents undesirable movements of the sliding latch 82, and includes bearings to reduce the sliding friction resulting from the movement of sliding latch 82. The point at which sliding latch 82 begins to slide away from saddle 74 of faceplate 64 can be adjusted by varying either the location of the pivotal connection of the latch arms 88 to the front side 56 of the baseplate 52, or the length and geometry of the latch arms 88 themselves, or both.

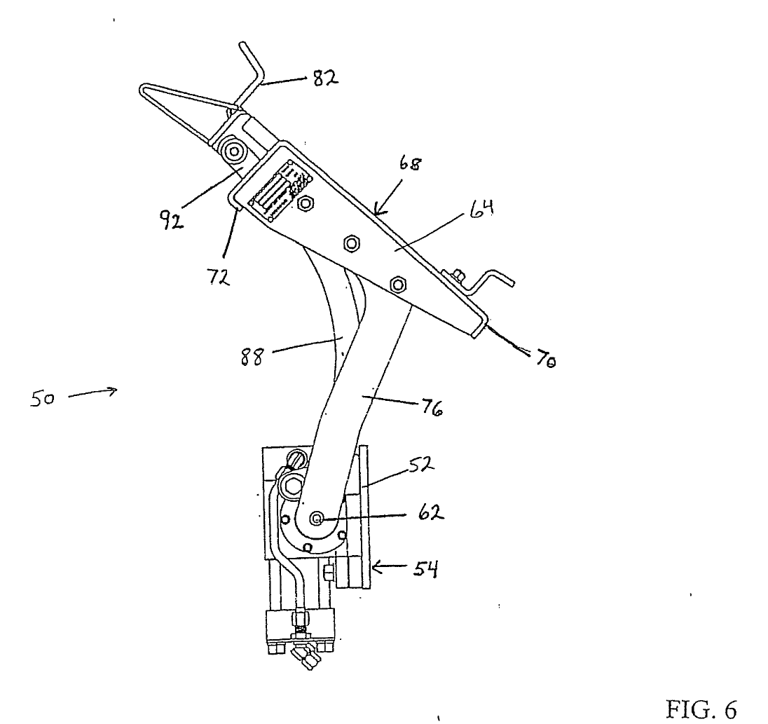

FIGS. 4 through 6 depict side views of the first embodiment of the present refuse cart lifter 50 shown in the retracted, intermediate and dumping positions, respectively. FIG. 4 shows one end of rotatable shaft 62. In addition, this figure shows that the lower end 72 of faceplate 64 may located below and substantially behind baseplate 52 when the lifter is in the retracted position. The unique geometry of the lifting arms 76 and the latch arms 88 can also be seen. Note the effect of the lift arm geometry as the lift arms 76 are rotated the full 210 degrees to the dumping position in FIG. 6. Also important is the slim profile depicted in the retracted configuration of FIG. 4, showing the faceplate 64, lifting arms 76, and latch arms 88 located substantially behind the outermost face 61 of motor 60. This facilitates the emptying of large commercial refuse containers over the refuse cart lifter, thereby enhancing the versatility of the refuse collection vehicle.

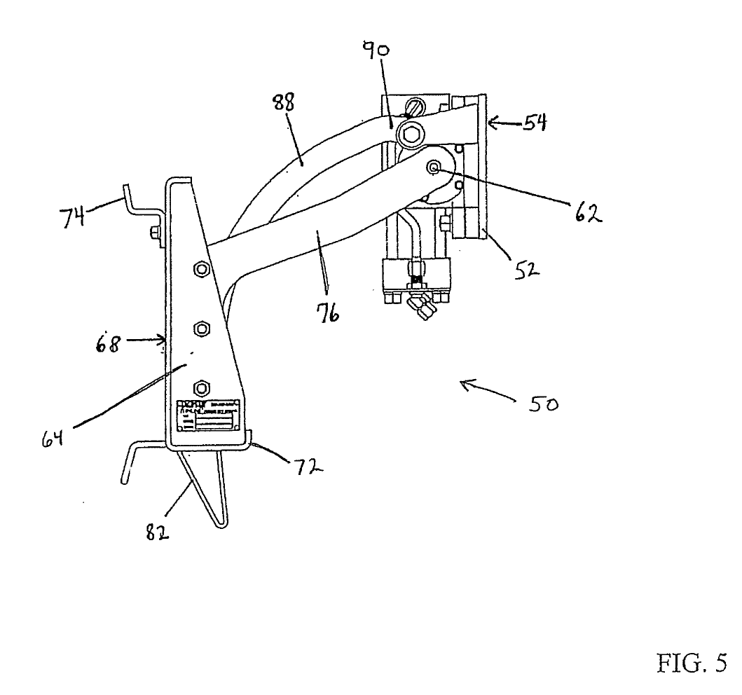

FIG. 5 depicts a side view of the first embodiment of the present refuse cart lifter 50 in an intermediate position. As in FIG. 2, the faceplate 64 is substantially parallel to baseplate 52. At this point, the movement of the latch arms 88 has not yet caused sliding latch 82 to slide away from saddle 74 of faceplate 64.

FIG. 6 depicts a side view of the first embodiment of the present refuse cart lifter 50 in the dumping position. Here, it can be observed that the relative connection points and geometries of lifting arms 76 and latch arms 88 have caused sliding latch 82 to slide away from saddle 74 of faceplate 64 as the faceplate 64 moved from the intermediate position shown in FIG. 5 to the dumping position in FIG. 6.

As discussed in reference to FIG. 3, the unique geometry of the lifting arms 76 coupled with 210 degrees of lifting arm 76 rotation from the retracted position serve to position the upper end 70 of faceplate 64 above and substantially behind baseplate 52. This facilitates the dumping of refuse further into the receiving refuse container than otherwise possible with conventional lifters.

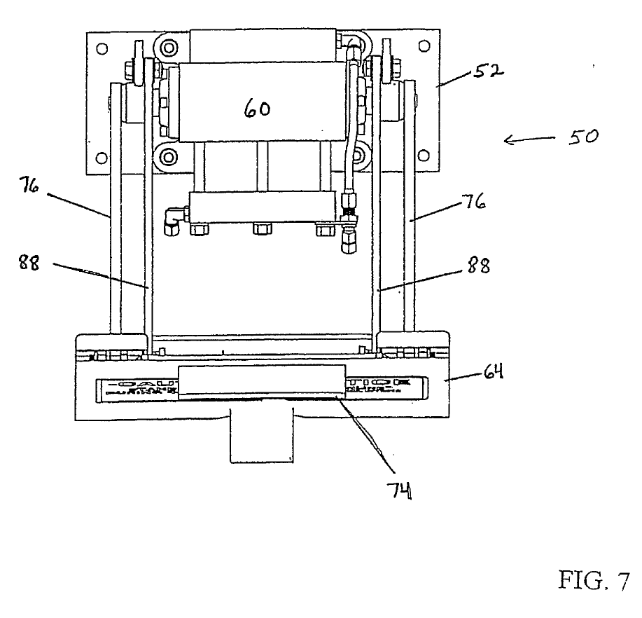

FIG. 7 depicts a front view of the first embodiment of the present refuse cart lifter 50 in the retracted position. This view shows the vertical relation of faceplate 64 to the baseplate 52, with faceplate 64 positioned well beneath baseplate 52.

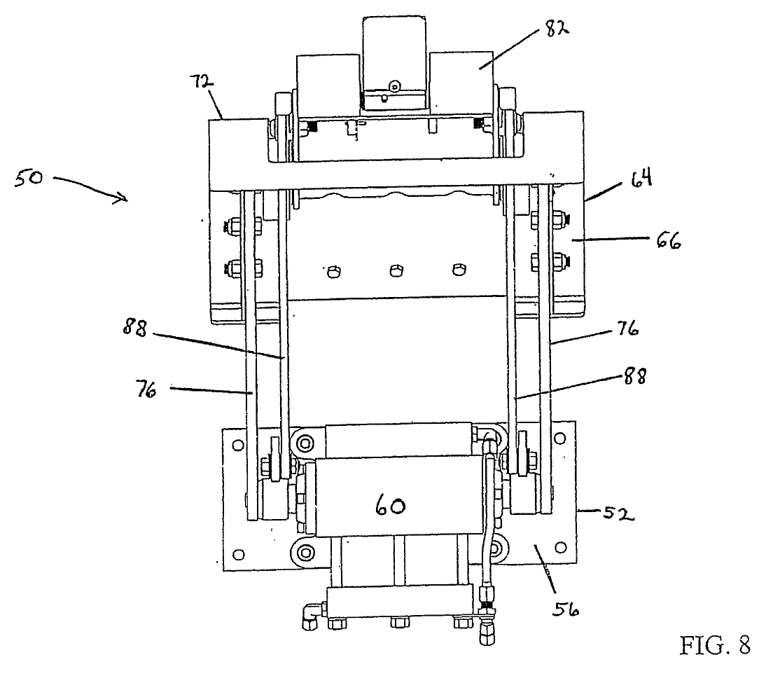

FIG. 8 depicts a front view of the first embodiment of the present refuse cart lifter 50 in the dumping position. This view shows the sliding latch 82 extended out from the lower end 72 of faceplate 64, and faceplate 64 positioned above baseplate 52.

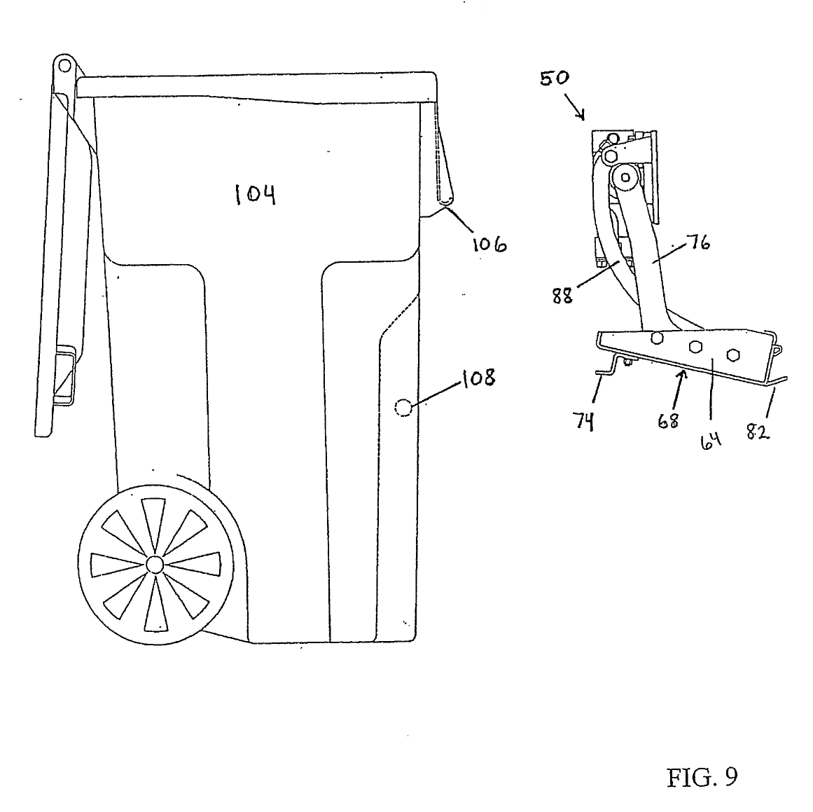

FIGS. 9 through 11 show a side view of the emptying of a refuse cart using the first embodiment of the present refuse cart lifter 50. Initially, an operator would position a refuse cart 104 adjacent to refuse cart lifter 50, as depicted in FIG. 9 (showing a side view of the first embodiment of the present refuse cart lifter 50 in the retracted position). The upper lifting point 106 and lower lifting point 108 of refuse cart 104 are also illustrated.

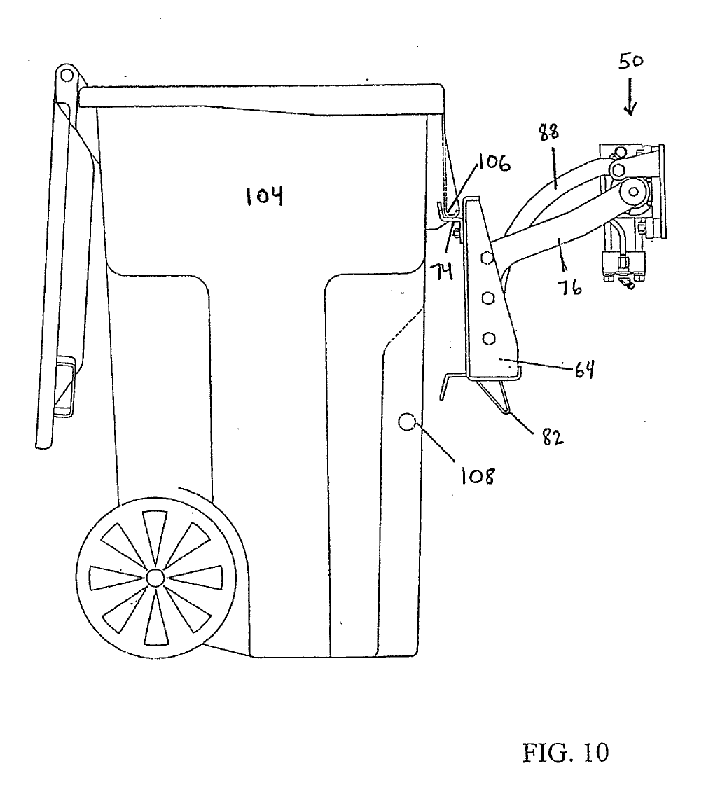

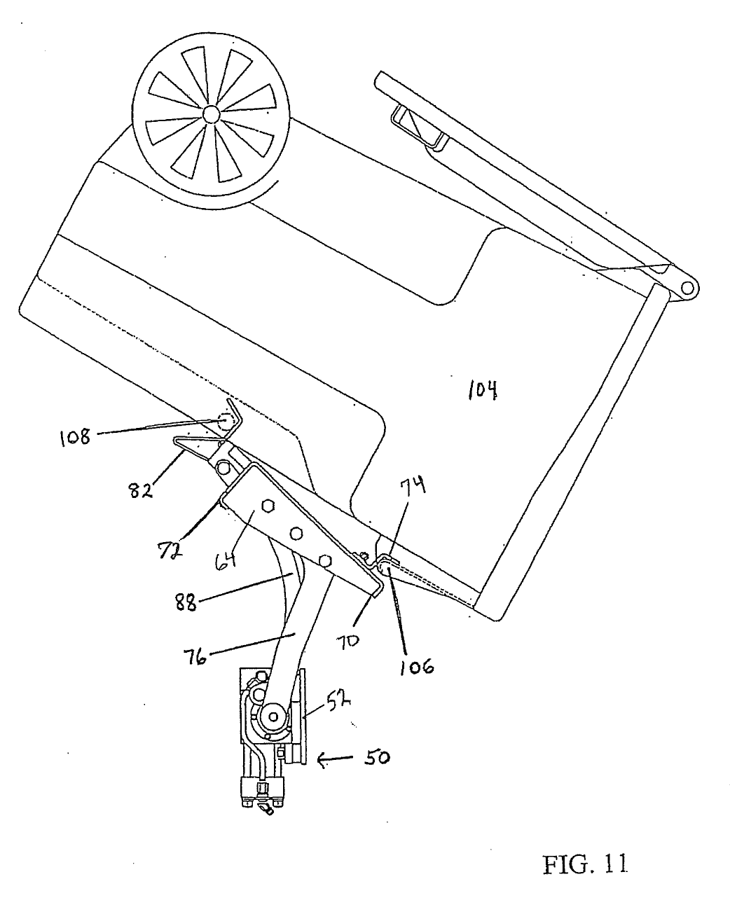

Once refuse cart 104 is positioned adjacent to refuse cart lifter 50, refuse cart lifter 50 would be operated to rotate lifting arms 76 to swing faceplate 64 up such that saddle 74 engages refuse cart upper lifting point 106 as seen in FIG. 10. FIG. 11 depicts the dumping position of lifter 50, which is reached after the continued rotation of lifting arms 76 from the intermediate position in FIG. 10 causes the upper end 70 of faceplate 64 to swing over and substantially behind baseplate 52, thereby dumping refuse from the refuse cart 104 far behind baseplate 52. In addition, while faceplate 64 is rotating from the intermediate position depicted in FIG. 10 to the emptying position shown here in FIG. 11, the relative geometries of lifting arms 76 and latch arms 88 cause sliding latch 82 to slide out and away from saddle 74 of faceplate 64 and engage refuse cart lower lifting point 108. This prevents refuse cart 104 from falling into the refuse collection area when saddle 74 is inverted as seen in FIG. 11.

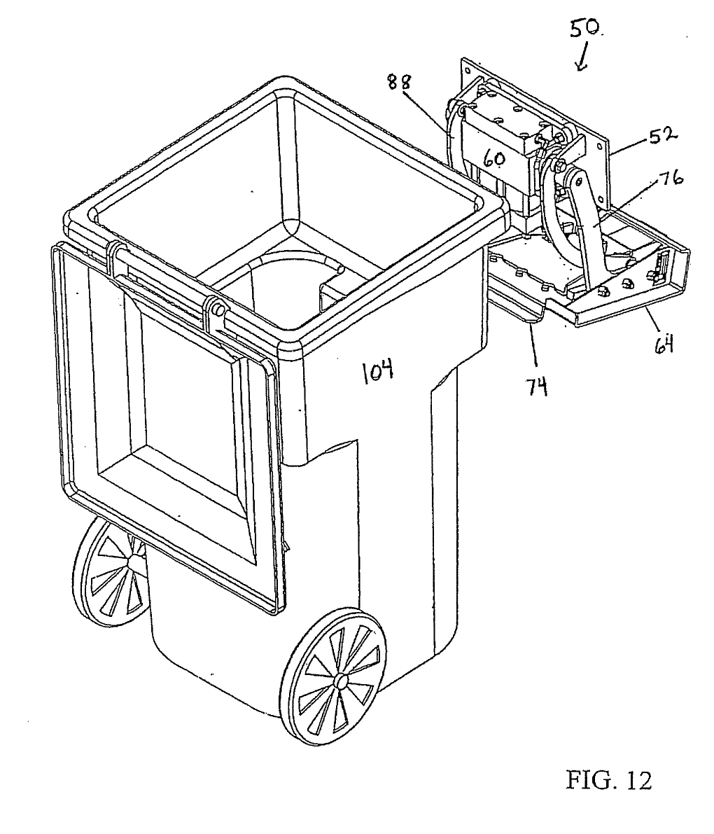

FIGS. 12 through 14 depict the same sequence of events as FIGS. 9 through 11 during the emptying of refuse container 104, but from a perspective view. Refuse cart lifter 50 is shown in a retracted position adjacent to refuse cart 104 in FIG. 12. FIG. 13 depicts the refuse cart lifter 50 engaging refuse cart upper lifting point 106 (not visible in this view) after lifting arms 76 have swung faceplate 64 up and away from baseplate 52. Finally, FIG. 14 shows the refuse cart lifter 50 faceplate 64 swung to the dumping position with both saddle 74 and sliding latch 82 engaging refuse cart 104 at lifting points 106 and 108, respectively (not visible in this view).

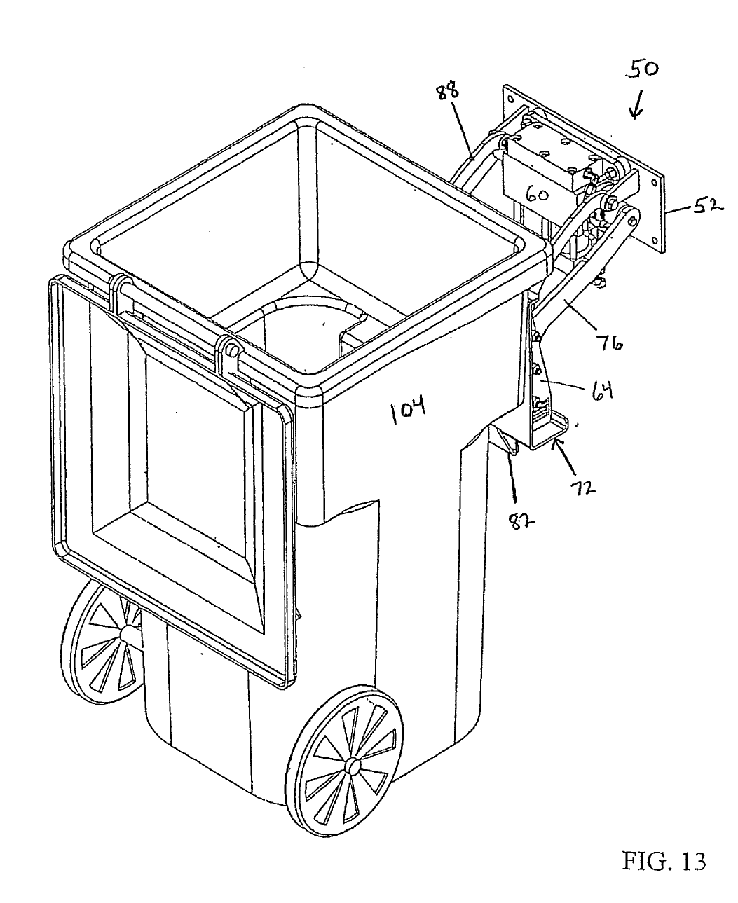

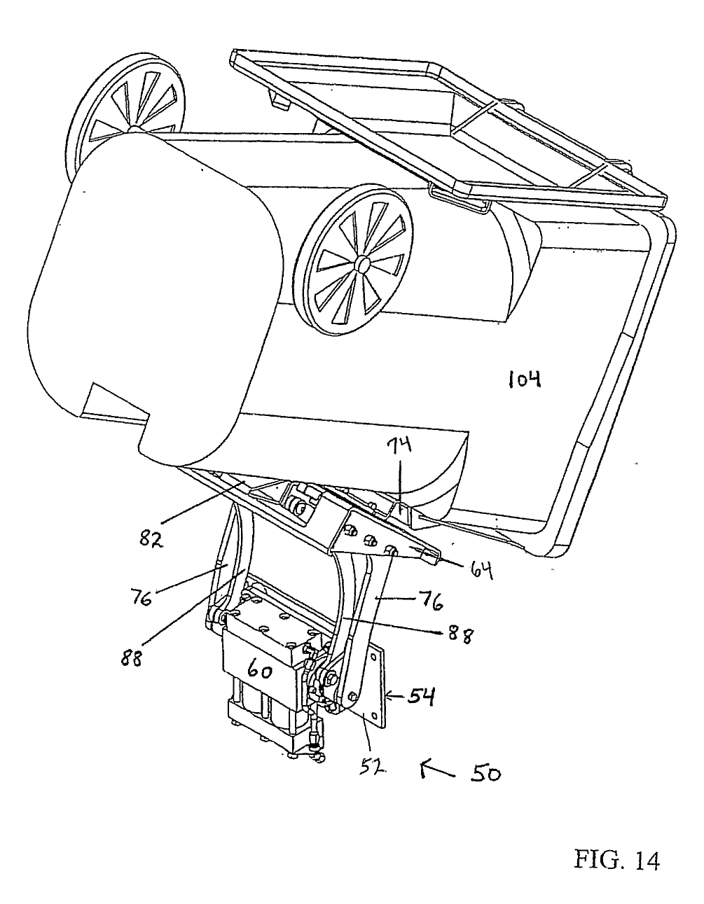

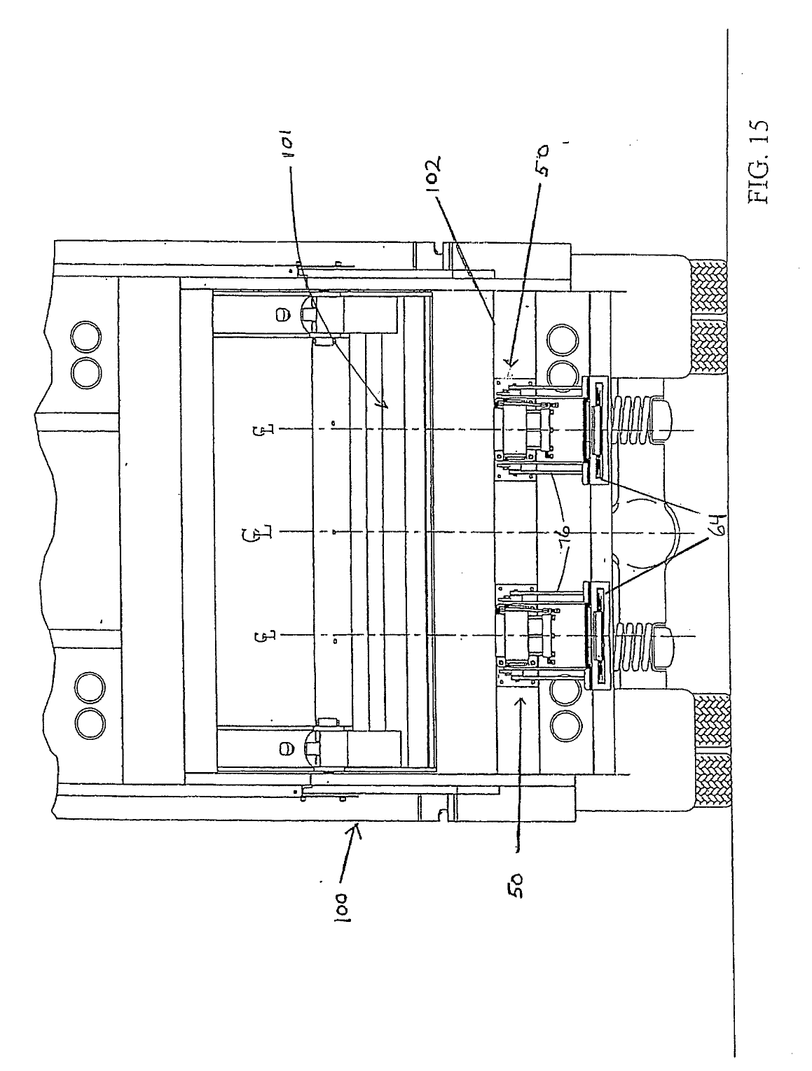

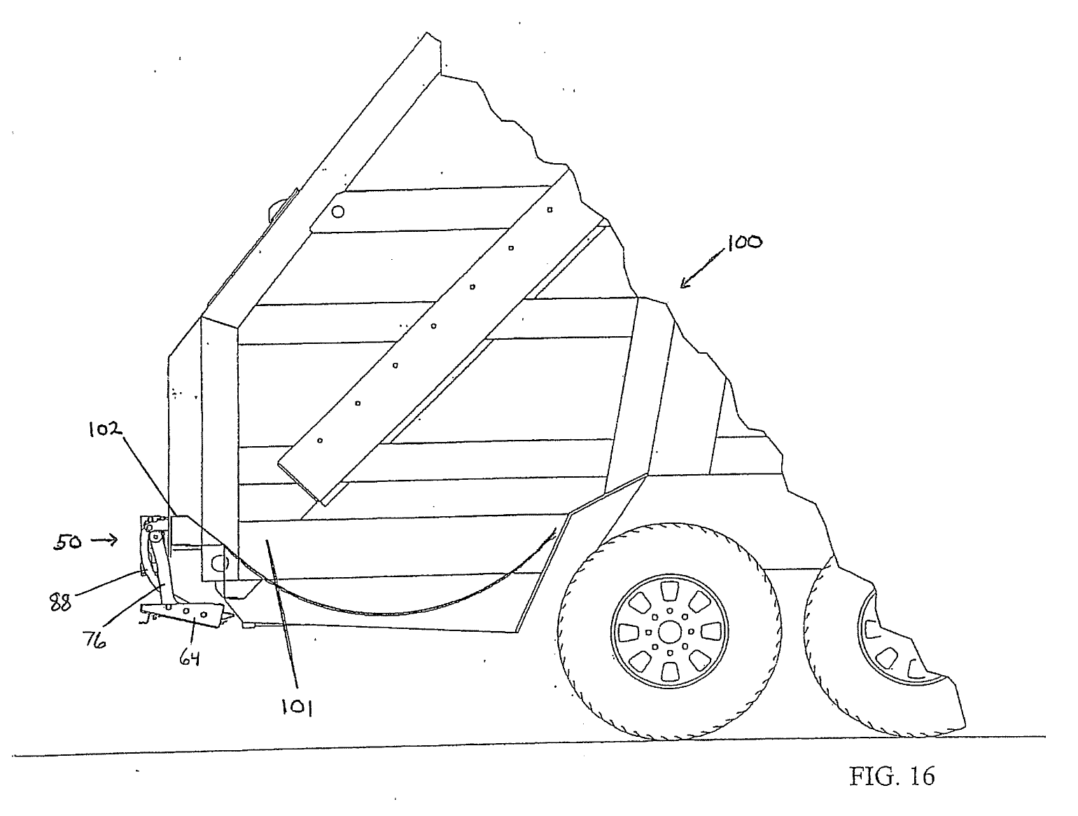

FIG. 15 depicts dual lifters 50 mounted to a refuse collection vehicle 100. The refuse hopper 101 is shown, as is lower hopper edge 102. As discussed previously, when refuse cart lifters 50 are operated to empty a refuse cart 104 (see, e.g., FIG. 12), lifting arms 76 will cause faceplate 64 to swing over and substantially inward of lower hopper edge 102. This can be seen by examining FIGS. 16 and 17, which depict a refuse cart lifter 50 mounted on a rear-loading refuse collection vehicle 100.

FIG. 16 depicts refuse cart lifter 50 shown in a retracted position and attached to a refuse collection vehicle 100. This figure emphasizes the slim side profile of the lifter 50, which facilitates the dumping of large commercial containers over the refuse cart lifter 50 when refuse cart lifter 50 is in the retracted position. FIG. 17 depicts the refuse cart lifter 50 in a the dumping position, and offers a cutaway view (represented by jagged lines) of the refuse collection vehicle hopper showing the upper end 70 of faceplate 64 angled over the baseplate 52 and extending substantially inward of lower hopper edge 102. An embodiment of the present invention could also be readily mounted to a side-loading refuse collection vehicle (not shown). It should be understood that the term “refuse collection vehicle” is intended to be understood broadly to include any type of vehicle for receiving refuse such as, for example, front, rear or side-loading vehicles, dumpsters, intermediate containers, and the like.

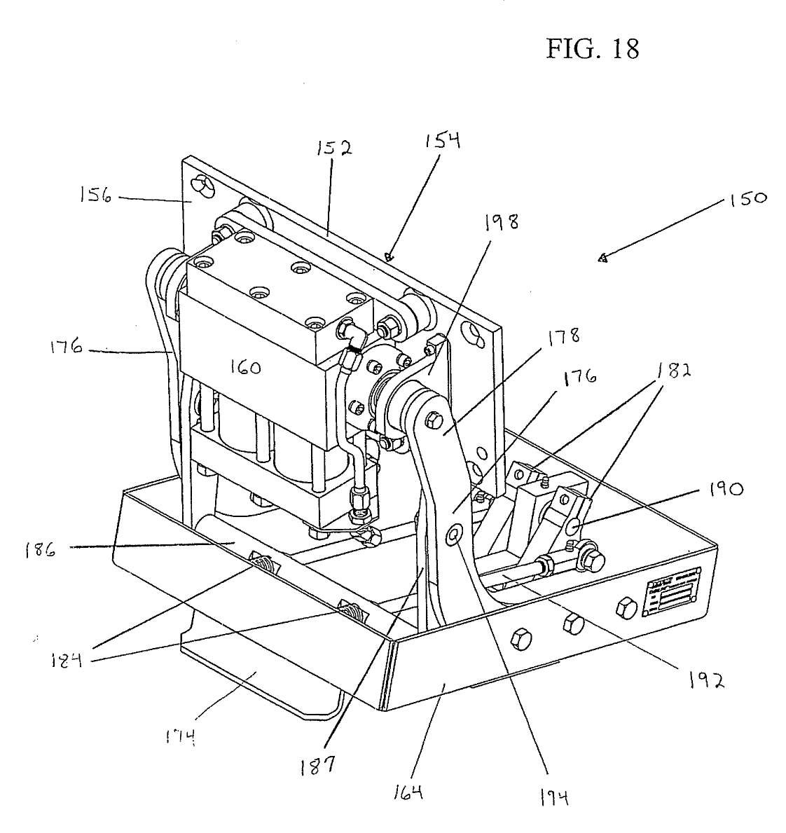

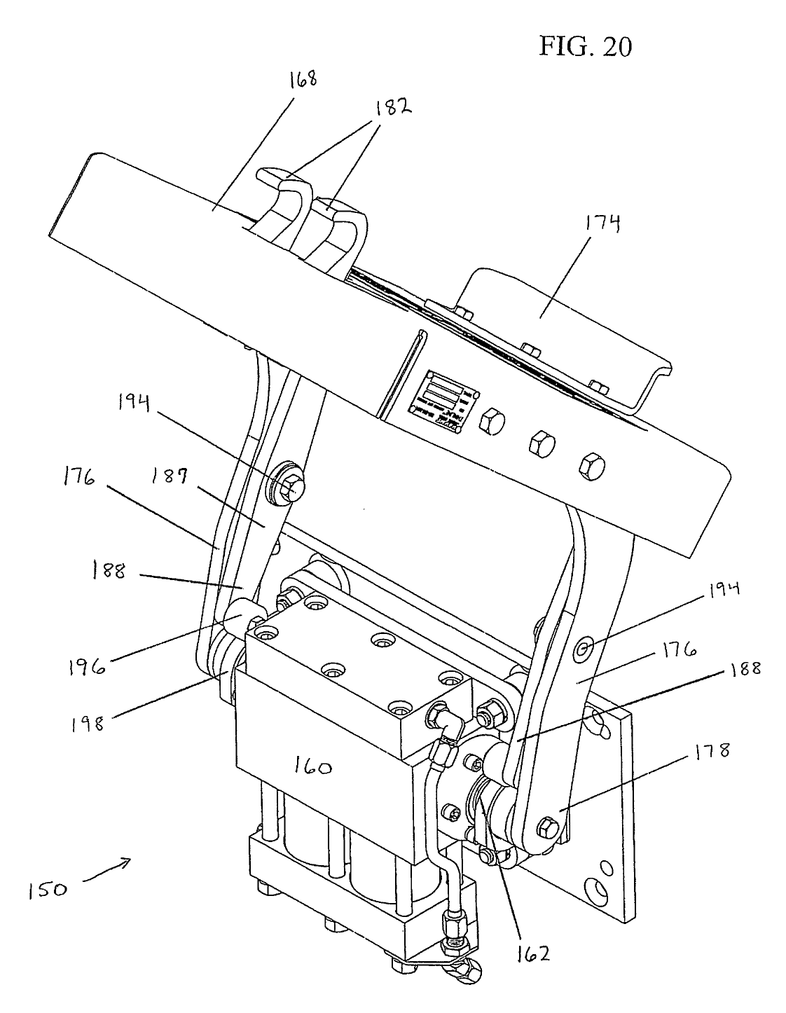

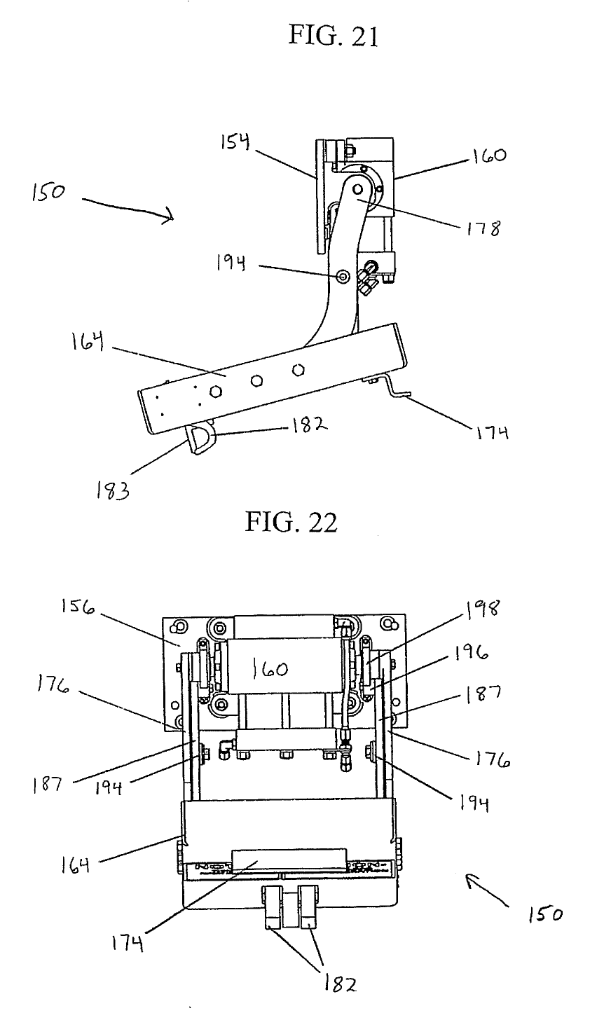

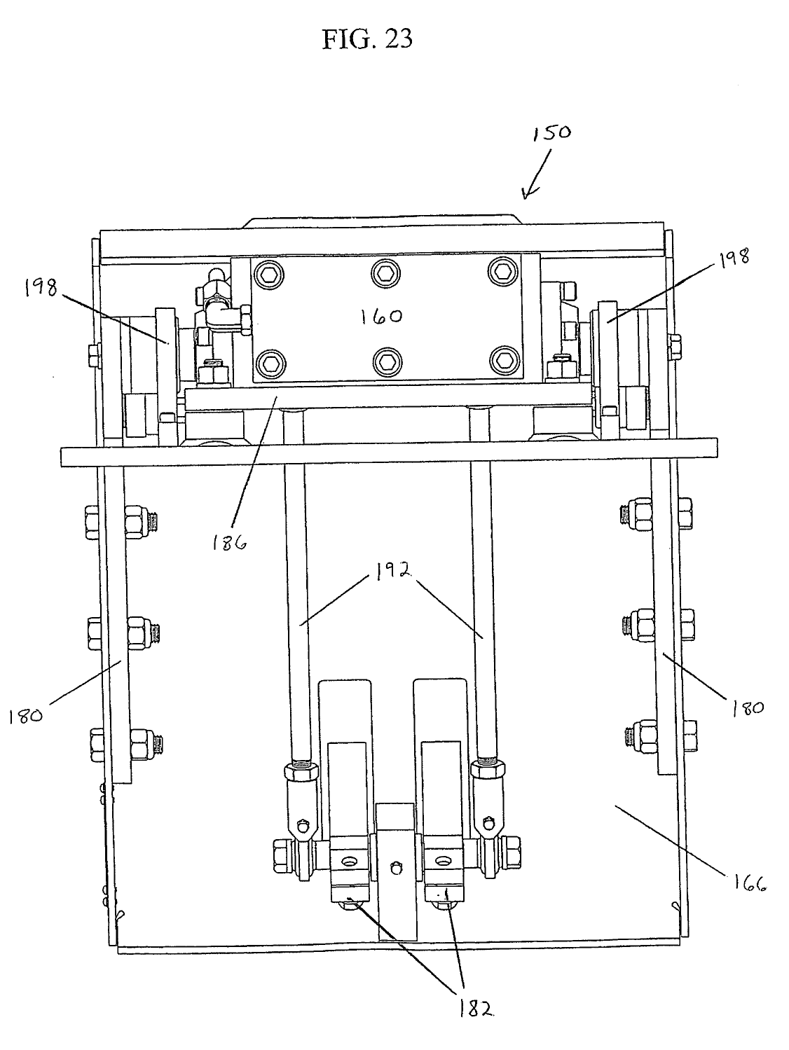

A second embodiment of the present refuse cart lifter 150 is depicted in FIGS. 18 through 23. FIG. 18 depicts refuse cart lifter 150 positioned in a retracted position. The motor 160 is affixed to the front side 156 of the baseplate 152. The motor depicted is a dual rack, single pinion hydraulic actuator capable of 210 degrees of rotation. The rear side 154 of baseplate 152 can be attached to a refuse collection vehicle or a large refuse collection container. Dual lifting arms 176 are attached to the rotatable shaft 162 (see FIG. 20) of motor 160 at a first end 178 of the lifting arms 176. The second end 180 (see FIG. 23) of lifting arms 176 are attached to faceplate 164.

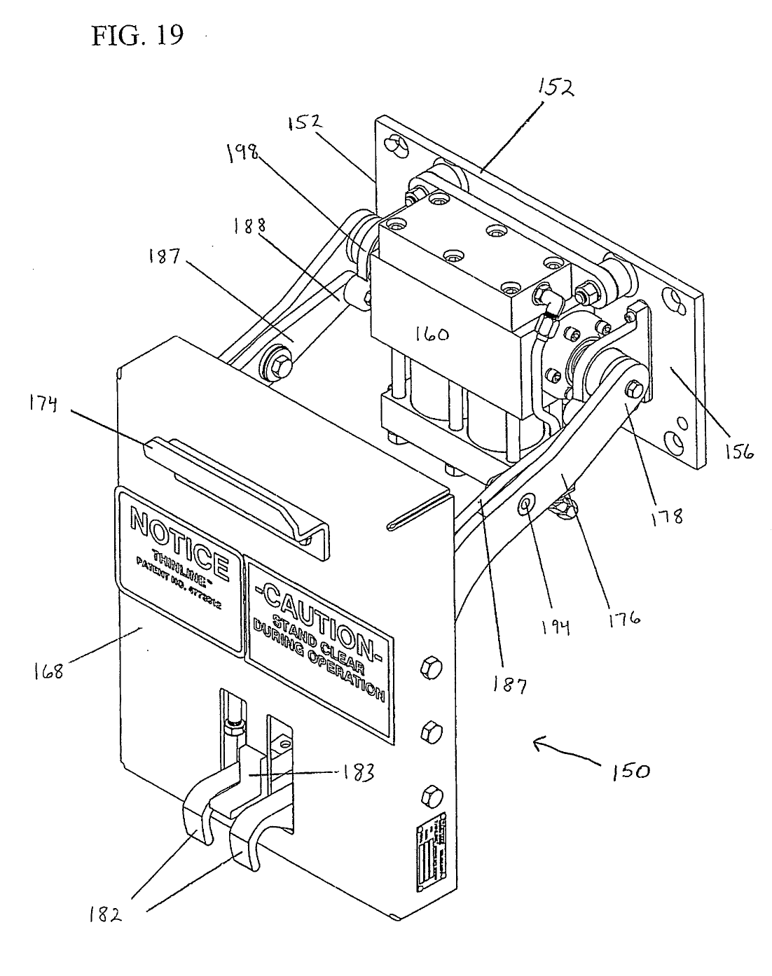

As lifter 150 lifting arms 176 are rotated, attached faceplate 164 swings in a corresponding arc as lifter 150 is either extended (see FIGS. 19 and 20) or retracted (see FIG. 18), similar to the operation of the first embodiment relating to refuse cart lifter 50. Unlike the first embodiment of the present lifter 50 that uses a sliding latch 82, however, lifter 150 utilizes a spring loaded, cam actuated rotating latch 182.

FIGS. 18 through 23 illustrate that rotating latch 182 is attached to actuating rod 192 that is itself attached to rotatable actuating arm 187. Rotatable actuating arm 187 in turn is connected to lifting arm 176 such that actuating arm 187 can rotate in a scissors-like fashion in conjunction with the movement of lifting arm 176 at attachment point 194. One end of actuating arm 187 tracks cam 198 via cam follower 196 (best seen in FIG. 20). The other end of actuating arm 187 is attached to rotating latch spring bar 186 (see FIG. 18), which is turn linked to rotating latch actuating rods 192 having springs 184. Spring tension provided by springs 184 serves to ensure that cam follower 196 stays in contact with cam 198 (see FIG. 20). When actuating arm 187 rotates, springs 184 are free to move rotating latch actuating rods 192, which in turn engages the rotating latches 182 by pivoting rotating latches 182 around latch rod 190. A refuse container can thus be held between rotating latch 182 and saddle 174 (see FIG. 19). However, when lifter 150 is in the dumping position shown in FIG. 20, the weight of a refuse cart may act against springs 184 and disengage the refuse container. To prevent such disengagement, a positive stop 183 (shown in FIG. 19) is located on the outer surface 168 of faceplate 164 to alleviate such action against springs 184.

Once the refuse container has been emptied, actuating arm 187 tracks cam 198 as lifting arms 176 are rotated back to a fully or partially retracted position, and rotating latch spring bar 186 opposes springs 184 to move rotating latch actuating rods 192 towards springs 184. Rotating latches 182 consequently rotate around latch rod 190 and gradually disengage the refuse container as lifter 150 moves into a fully or partially retracted position.

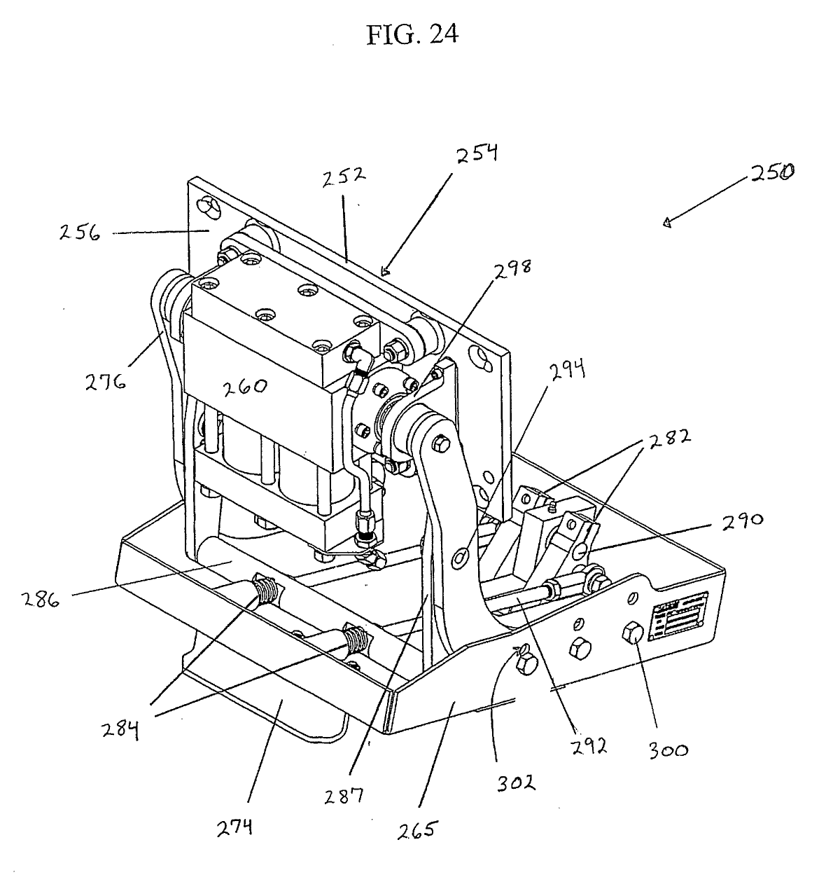

A third embodiment of the present invention is depicted in FIG. 24. This embodiment is similar to the second embodiment of the invention in basic structure and operation, but unlike the other embodiments of the present invention, this embodiment employs an adjustable connection between faceplate 265 and lifting arms 276. This adjustable connection may employ multiple sets of attachment points 300 and 302 on faceplate 265 for connecting lifting arms 276 to faceplate 265. Thus, the assembled configuration of faceplate 265 with respect to lifting arms 276 is adjustable, which facilitates the mounting of refuse cart lifter 250 at a range of mounting heights without changing lifting arm lengths. While FIG. 24 depicts lifter 250 faceplate 265 as having two sets of attachment points for lifting arms 276, more attachment points are contemplated. In FIG. 24, faceplate 265 is depicted attached to lifting arms 276 at a first set of attachment points 300. The second set of mounting points 302 for lifting arms 276 are not in use.

It should be understood that while the third embodiment depicts attachment points 300 and 302 on faceplate 265, the present invention is not so limited. For instance, attachment points 300 and 302 could be located on lifting arms 276. Similarly, while the third embodiment depicts the use of nuts and bolts to attach faceplate 265 to lifting arms 276, other means of attachment known to persons of skill in the art, such as clamps, pins, etc., may also be used.

The detailed operation of lifter 250 is similar to the above description of operation relating to lifter 150 with the exception of adjustable faceplate 265. For example, FIG. 24 depicts lifter 250 having a spring loaded, cam actuated rotating latch 282 as described with respect to lifter 150 above. Parts of lifter 250 shared with lifter 150 are identified with similar reference numbers that correspond to the numerals used with respect to lifter 150. Thus, lifter 250 has a baseplate 252 having a rear side 254 and a front side 256. Motor 260 is attached to baseplate 252 and drives lifting arms 276, which are in turn attached to faceplate 265. Faceplate 265 has an attached saddle 274 that, in conjunction with rotating latch 282, serves to engage and hold refuse cart during the emptying of the cart.

Rotating latch 282 is attached to actuating rod 292 that is itself attached to rotatable actuating arm 287. Rotatable actuating arm 287 in turn is connected to lifting arm 276 such that actuating arm 287 can rotate in a scissors-like fashion in conjunction with the movement of lifting arm 276 at attachment point 294. One end of actuating arm 287 tracks cam 298 via a cam follower 296 (not seen in this view, but similar to the cam follower 196 of the second embodiment of lifter 150 shown in FIG. 22). The other end of actuating arm 287 is attached to rotating latch spring bar 286, which is turn linked to rotating latch actuating rods 292 having springs 284. Spring tension provided by springs 284 serves to ensure that cam follower 296 stays in contact with cam 298 (not seen in this view). When actuating arm 287 rotates, springs 284 are free to move rotating latch actuating rods 292, which in turn engages the rotating latch 282 by pivoting rotating latch 282 around latch rod 290. A refuse container can thus be held between rotating latch 282 and saddle 274.

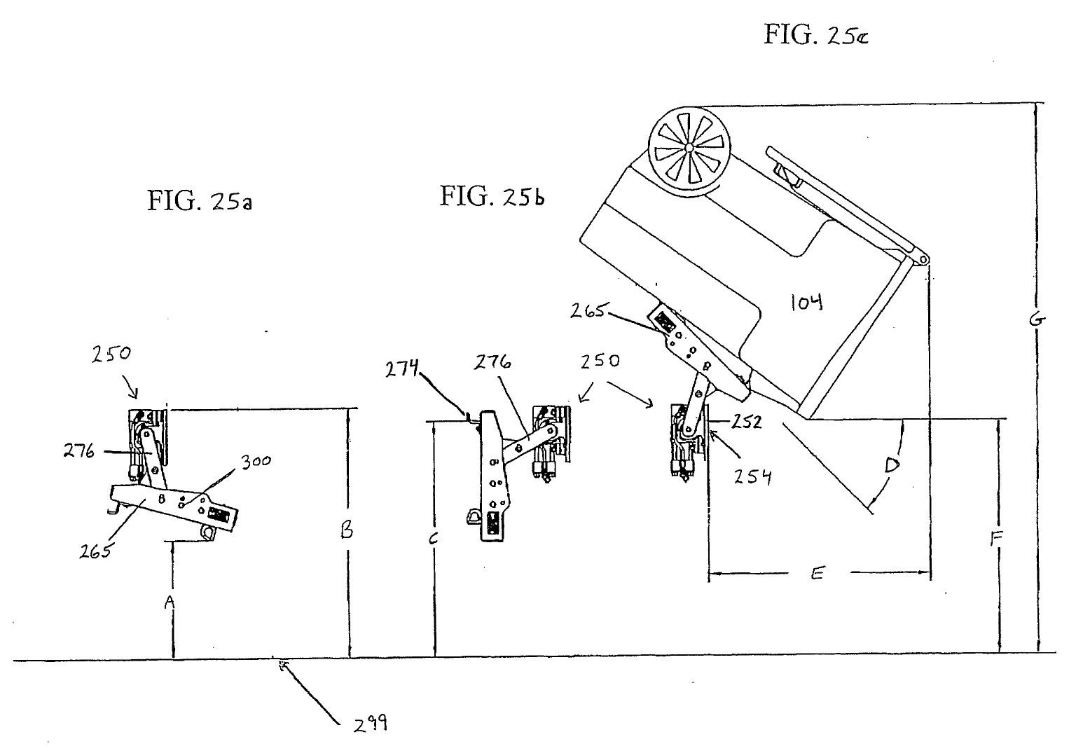

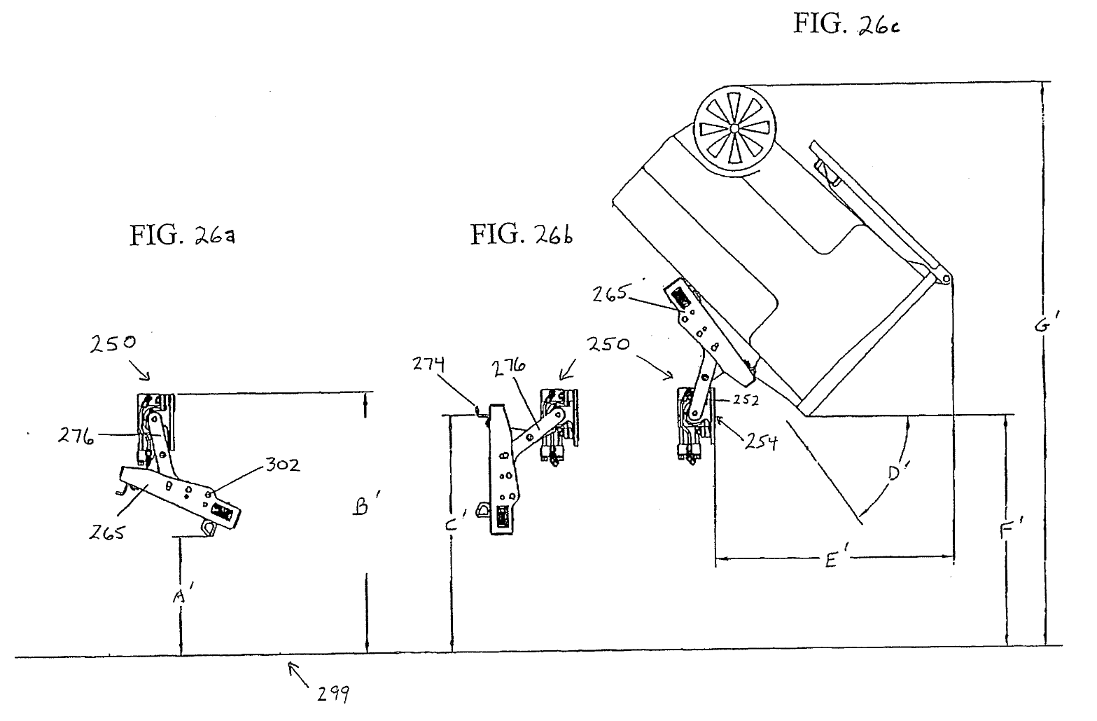

FIGS. 25a through 26c illustrate how adjusting faceplate 265 facilitates changing the mounting height of lifter 250 without necessitating the replacement of lifter arms 276 with arms of a different length to compensate for the mounting height difference. Turning to FIG. 25a, lifting arms 276 of a specific length are attached to adjustable faceplate 265 at a first set of mounting points 300. In this configuration, lifter 250 is mounted at mounting height B from the substantially level pickup surface 299 and presents a retracted ground clearance height of A when lifter 250 is in the retracted position shown. By way of illustration for comparison with the parameters shown in FIG. 26a for the same given set of lifter arms 276, Height A in this example is approximately 17.125 inches when lifter 250 is mounted at a height B of approximately 36 inches.

In FIG. 25b, adjustable faceplate 265 is extended to an intermediate position for engaging a refuse container wherein faceplate 265 is substantially perpendicular to a substantially level pickup surface 299. In this intermediate position, faceplate 265 is substantially parallel to a refuse container sitting on the substantially level pickup surface 299, and height C of saddle 274 is adequate for proper refuse container engagement and disengagement. In general, the preferred saddle height C is approximately 34 inches. Saddle height C in this example is also approximately 34 inches.

Finally, FIG. 25c shows lifter 250 in the extended dumping position with refuse cart 104, wherein adjustable faceplate 265 is positioned at angle D with respect to the horizontal. By way of illustration for comparison with the parameters shown in FIG. 26c for the same given set of lifter arms 276, angle D is approximately 45 degrees. Length E is the distance from the back side 254 of base plate 252 to the forward most portion of refuse cart 104. In this example, length E is approximately 32.5 inches. Height F represents the distance between the lower most portion of refuse cart 104 and substantially level pickup surface 299. In this example, height F is approximately 33.75 inches. Finally, height G is the distance between the uppermost portion of refuse container 104 and substantially level pickup surface 299. In this particular example, height G is approximately 78.875 inches.

FIGS. 26a through 26c correspond to FIGS. 25a through 25c, respectively. FIGS. 26a through 26c use identical lifting arms 276 to lifting arms 276 used in FIGS. 25a through 25c. In FIG. 26a, adjustable faceplate 265 has been adjusted by attaching the same lifting arms 276 from FIGS. 25a through 25c at attachment points 302 instead of attachment points 300. Lifter 250 mounting height B has been raised to height B′, which, by way of specific example only, is approximately 37.5 inches. Height A then changes to height A′. In this example, A′ is approximately 17 inches.

By moving the attachment points of lifting arms 276 to set of attachment points 302, it is possible for lifter 250 to achieve a height C′ of saddle 274 that is substantially the same as height C of saddle 274 in the intermediate position despite increased mounting height B′. This adjustment does not adversely affect the operation of lifter 250 in any significant way.

For instance, by way of comparison with FIG. 25c, using the same lifter arms 276 used in FIG. 26c alters angle D from approximately 45 degrees to approximately 54 degrees. Length E increases from approximately 32.5 inches to 35 inches. Height F slightly decreases from approximately 33.75 inches to 33.25 inches. Finally, height G increases from approximately 78.875 inches in FIG. 25c to 80.875 inches in FIG. 26c.

The adjustable faceplate 265 of lifter 250 discussed above with respect to FIGS. 25a through 26c can be mounted over a range of mounting heights. By way of example only, the specific embodiment of lifter 250 depicted in FIGS. 25a through 26c using lifting arms 276 of a set length may be capable of operating over a range of mounting heights from a low mounting height B of at least approximately 36 inches to a high mounting height B′ of at least approximately 39.5 inches while maintaining saddle height C at a height adequate for proper refuse container engagement and disengagement. Changes to lifter arm 265 length and configuration will lead to other ranges of mounting heights. For example, substituting a second set of lifter arms 265 that are approximately 2 inches longer than lifting arms 265 in the example discussed in FIGS. 25a through 26c will result in a lifter 250 that may be capable of operating over a range of mounting heights from a low mounting height B of at least approximately 37.875 inches to a high mounting height B′ of at least approximately 40.875 inches while maintaining saddle height C at a height adequate for proper refuse container engagement and disengagement. Even longer lifting arms 276 may result in an even higher operable range of lifter 250 mounting heights B. For example, the mounting height may range from a low mounting height B of at least approximately 40 inches to a high mounting height B′ of at least approximately 43 inches while maintaining saddle height C at a height adequate for proper refuse container engagement and disengagement. Those of skill in the art will appreciate, of course, that other lifter arm 265 configurations and attachment points will further alter the operable parameters of lifter 250.

The words used above are words of description rather than of limitation. Although preferred embodiments of the invention have been described using specific terms, devices, relative positions, and methods, such description is for illustrative purposes only. It should be understood that aspects of the various embodiments may be interchanged both in whole or in part. Therefore, the spirit and scope of the appended claims should not be limited to the description of the preferred versions contained therein.

For example, the present refuse cart lifter could utilize a single lifting arm or a single latch arm, or various multiples of each or both. Furthermore, the lifter could be mounted to freestanding refuse containers, intermediate containers, rear-loading refuse collection vehicles, or side-loading refuse collection vehicles. Thus, it should be understood that changes and variations may be made by those of ordinary skill in the art without departing from the spirit or the scope of the present invention, which is set forth in the following claims.

What is claimed is:

1. A refuse cart lifting device comprising:
a baseplate having a front side and a back side, the baseplate adapted to be mounted to a refuse collection vehicle;
a motor attached to the front side of the baseplate, the motor having a rotatable shaft;
a faceplate, the faceplate having an outer surface and an inner surface, and the faceplate also having an upper and a lower end;
a saddle fixedly attached to the outer surface of the faceplate;
at least one lifting arm of a fixed length having a first end and a second end, the first end of the at least one lifting arm attached to the rotatable shaft, the second end of the at least one lifting arm adjustably attached to the faceplate; and
a latch that cooperates with the saddle to engage and hold refuse carts during operation of the lifter.

2. The refuse cart lifting device of claim 1, where the motor is capable of rotating the rotatable shaft at least 210 degrees.

3. The refuse cart lifting device of claim 1, where the at least one lifting arm is configured to direct the faceplate above and substantially behind the baseplate when the lifter is emptying a refuse cart.

4. The refuse cart lifting device of claim 1, wherein the lower end of the faceplate is capable of being retracted below and substantially behind the baseplate when the refuse cart lifting device is not in use, and the upper end of the faceplate is capable of being rotated above and substantially behind the baseplate when the lifting device is emptying a refuse cart.

5. The refuse cart lifting device of claim 1, wherein the latch comprises:
a rotating latch spring bar;
at least one actuating arm, the at least one actuating arm having a first end and a second end, the at least one actuating arm having a point between the first end of the at least one actuating arm and the second end of the at least one actuating arm which is pivotally attached to the at least one lifting arm at a point between the first end of the at least one lifting arm and the second end of the at least one lifting arm, the first end of the at least one actuating arm connected to a cam follower in sliding contact with the cam, and the second end of the at least one actuating arm attached to the rotating latch spring bar;
at least one latch actuating rod, the at least one latch actuating rod having a first end and a second end, the first end of the latch actuating rod linked to the rotating latch spring bar, the second end of the at least one latch actuating rod attached to a latch rod, the latch rod pivotally attached to the faceplate;
at least one spring, a first end of the at least one spring acting against the faceplate, a second end of the at least one spring acting against the rotating latch spring bar;
a rotating latch, the rotating latch attached to a portion of the latch rod and rotatable with the latch rod to engage and hold refuse carts during operation of the lifter in conjunction with the saddle, the rotating latch extending through the faceplate during engagement.

6. The refuse cart lifting device of claim 1, where the baseplate is attached to a refuse collection vehicle.

7. The refuse cart lifting device if claim 1, where the faceplate further comprises at least two sets of attachment points for attachment of the faceplate to the at least one lifting arm.

8. A refuse collection vehicle, the refuse collection vehicle including a refuse hopper for the collection of trash, the refuse hopper having a lower hopper edge over which refuse carts may be emptied into the refuse hopper, the refuse collection vehicle further including a refuse cart lifting device, the refuse cart lifting device comprising:
a baseplate attached to the refuse collection vehicle below and adjacent to the hopper edge, the baseplate having a front side facing away from the refuse collection vehicle and a back side facing the refuse collection vehicle;
a motor attached to the front side of the baseplate, the motor having a rotatable shaft;
a faceplate, the faceplate having an outer surface and an inner surface, and the faceplate also having an upper and a lower end;
a saddle fixedly attached to the outer surface of the faceplate;
at least one lifting arm of a fixed length having a first end and a second end, the first end of the at least one lifting arm attached to the rotatable shaft, the second end of the at least one lifting arm adjustably attached to the faceplate; and
a latch that cooperates with the saddle to engage and hold refuse carts during operation of the lifter.

9. The refuse cart lifting device of claim 8, where the motor is capable of rotating the rotatable shaft at least 210 degrees.

10. The refuse cart lifting device of claim 8, where the at least one lifting arm is configured to direct the faceplate above and substantially behind the baseplate when the lifter is emptying a refuse cart.

11. The refuse cart lifting device of claim 8, where the lower end of the faceplate is capable of being retracted below and substantially behind the baseplate when the refuse cart lifting device is not in use, and the upper end of the faceplate is capable of being rotated above and substantially inward of the lower hopper edge when the lifting device is emptying a refuse cart.

12. The refuse cart lifting device of claim 8, wherein the latch comprises:
a rotating latch spring bar;
at least one actuating arm, the at least one actuating arm having a first end and a second end, the at least one actuating arm having a point between the first end of the at least one actuating arm and the second end of the at least one actuating arm which is pivotally attached to the at least one lifting arm at a point between the first end of the at least one lifting arm and the second end of the at least one lifting arm, the first end of the at least one actuating arm connected to a cam follower in sliding contact with the cam, and the second end of the at least one actuating arm attached to the rotating latch spring bar;
at least one latch actuating rod, the at least one latch actuating rod having a first end and a second end, the first end of the latch actuating rod linked to the rotating latch spring bar, the second end of the at least one latch actuating rod attached to a latch rod, the latch rod pivotally attached to the faceplate;
at least one spring, a first end of the at least one spring acting against the faceplate, a second end of the at least one spring acting against the rotating latch spring bar;
a rotating latch, the rotating latch attached to a portion of the latch rod and rotatable with the latch rod to engage and hold refuse carts during operation of the lifter in conjunction with the saddle, the rotating latch extending through the faceplate during engagement.

13. The refuse cart lifting device of claim 8, where the refuse collection vehicle is a rear-loading vehicle.

14. The refuse collection vehicle of claim 8, where the refuse collection vehicle is a side-loading vehicle.

15. The refuse cart lifting device of claim 8 where the faceplate further comprises at least two sets of attachment points for attachment of the faceplate to the at least one lifting arm.

16. A method for adapting a refuse cart lifting device having a faceplate and at least one lifting arm that facilitates the mounting of the refuse cart lifting device on a refuse collection vehicle over a range of mounting heights, the method comprising:
detaching the at least one lifting arm from the faceplate at a first attchment point;
reattaching the at least one lifting arm to the faceplate at a second attachment point.

17. The method of claim 16, wherein the refuse cart lifting device comprises:
a baseplate having a front side and a back side, the baseplate adapted to be mounted to a refuse collection vehicle;
a motor attached to the front side of the baseplate, the motor having a rotatable shaft;
a faceplate, the faceplate having an outer surface and an inner surface, and the faceplate also having an upper and a lower end;
a saddle fixedly attached to the outer surface of the faceplate;
at least one lifting arm of a fixed length having a first end and a second end, the first end of the at least one lifting arm attached to the rotatable shaft, the second end of the at least one lifting arm adjustably attached to the faceplate; and
a latch that cooperates with the saddle to engage and hold refuse carts during operation of the lifter.

18. The refuse cart lifting device of claim 17, wherein the latch comprises:
a rotating latch spring bar;
at least one actuating arm, the at least one actuating arm having a first end and a second end, the at least one actuating arm having a point between the first end of the at least one actuating arm and the second end of the at least one actuating arm which is pivotally attached to the at least one lifting arm at a point between the first end of the at least one lifting arm and the second end of the at least one lifting arm, the first end of the at least one actuating arm connected to a cam follower in sliding contact with the cam, and the second end of the at least one actuating arm attached to the rotating latch spring bar;
at least one latch actuating rod, the at least one latch actuating rod having a first end and a second end, the first end of the latch actuating rod linked to the rotating latch spring bar, the second end of the at least one latch actuating rod attached to a latch rod, the latch rod pivotally attached to the faceplate;
at least one spring, a first end of the at least one spring acting against the faceplate, a second end of the at least one spring acting against the rotating latch spring bar;
a rotating latch, the rotating latch attached to a portion of the latch rod and rotatable with the latch rod to engage and hold refuse carts during operation of the lifter in conjunction with the saddle, the rotating latch extending through the faceplate during engagement.

19. The refuse cart lifting device of claim 16 where the faceplate further comprises at least two sets of attachment points for attachment of the faceplate to the at least one lifting arm.
